(19) United States
(12) Patent Application Publication
(10) Pub. No.: US 2021/0075734 A1
(43) Pub. Date: Mar. 11, 2021

(54) PACKETS TRANSMISSIONS BASED ON PRIORITY LEVELS

(71) Applicant: Hewlett-Packard Development Company, L.P., Spring, TX (US)

(72) Inventors: I-Chen Lin, Taipei City (TW); Han-Kuang Chang, Taipei City (TW); Yi-Ching Lin, Taipei City (TW)

(73) Assignee: Hewlett-Packard Development Company, L.P., Spring, TX (US)

(21) Appl. No.: 16/980,881

(22) PCT Filed: May 31, 2018
(86) PCT No.: PCT/US2018/035428

§ 371 Date: Sep. 15, 2020

(51) Int. Cl. H04L 12/851

(52) U.S. Cl. CPC H04L 47/2433

(57) ABSTRACT

In examples, a non-transitory computer-readable medium stores machine-readable instructions which, when executed by a processor of an electronic device, cause the processor to receive a packet, determine a priority level of the packet, calculate a delay time based on the priority level, and transmit the packet over a network upon an expiration of the delay time.

### BACKGROUND

Computer applications may transmit packets over a network. Networks may have limited bandwidth for transmission of packets. The available bandwidth may be shared by multiple computer applications of a computer system.

### BRIEF DESCRIPTION OF THE DRAWINGS

Various examples will be described below referring to the following figures:

FIG. 1 shows storage to store computer-readable instructions to calculate a delay time for a packet in accordance with various examples;

FIG. 2 shows storage to store computer-readable instructions to calculate a delay time for a packet and use of a priority queue in accordance with various examples;

FIG. 3 shows storage to store computer-readable instructions to calculate a delay time for a packet in accordance with various examples;

FIG. 4 shows a computer system to execute computer-readable instructions to calculate a delay time for a packet, according to an example; and

FIG. 5 shows packets being prioritized before transmission over a network, according to an example.

### DETAILED DESCRIPTION

Computer applications (implemented using processor executable instructions) may require a minimum bandwidth to provide a satisfactory user experience. When multiple applications attempt to transmit more data than can be transmitted by the available bandwidth, the available bandwidth is shared between the applications. If insufficient bandwidth is available to an application, such as a video chat, the performance of the application may be degraded.

A computer system may prioritize the transmission of a packet across the network based on the type of application associated with the packet. Packets corresponding to user-sensitive applications, such as voice or video chat, may be given higher priority. Packets corresponding to other applications, such as a file transfer, may be given a lower priority and delayed. When bandwidth is scarce, transmission of packets corresponding to lower priority applications may be delayed by an amount of time. The amount of time may be determined based on the expected amount of time before the network connection between the local application and its remote counterpart times out due to inactivity. Delaying the transmission of packets corresponding to lower priority applications may allow higher priority applications to be prioritized when bandwidth is scarce, yet still allow lower priority applications to maintain established network connections.

In one example in accordance with the present disclosure, an apparatus is provided. The apparatus comprises a non-transitory computer-readable medium storing machine-readable instructions which, when executed by a processor of an electronic device, cause the processor to: receive a packet, determine a priority level of the packet, calculate a delay time based on the priority level, and transmit the packet over a network upon an expiration of the delay time.

In one example in accordance with the present disclosure, an apparatus is provided. The apparatus comprises a non-transitory computer-readable medium storing machine-readable instructions which, when executed by a processor of an electronic device, cause the processor to: receive a first packet, receive a second packet after receiving the first packet, determine the first packet has a lower priority level than the second packet, calculate a delay time for the first packet based on the priority level of the first packet, store the first packet in a delay queue, transmit the second packet over a network, and transmit the first packet over the network after transmitting the second packet over the network.

In one example in accordance with the present disclosure, a system is provided. The system comprises a processor, a network interface connector coupled to the processor, and storage coupled to the processor to store machine-readable instructions, wherein execution of the machine-readable instructions by the processor causes the processor to: receive a packet, determine an application corresponding to the packet, calculate a delay time based on the application, and transmit the packet over a network via the network interface connector upon an expiration of the delay time.

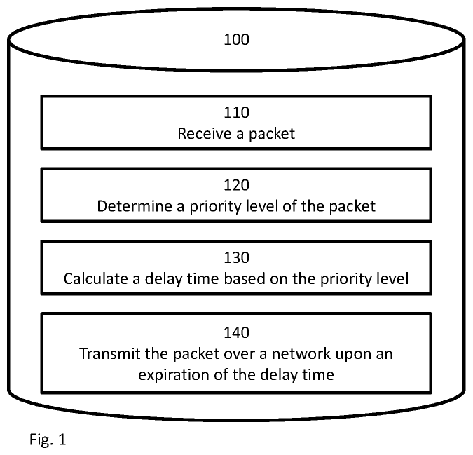

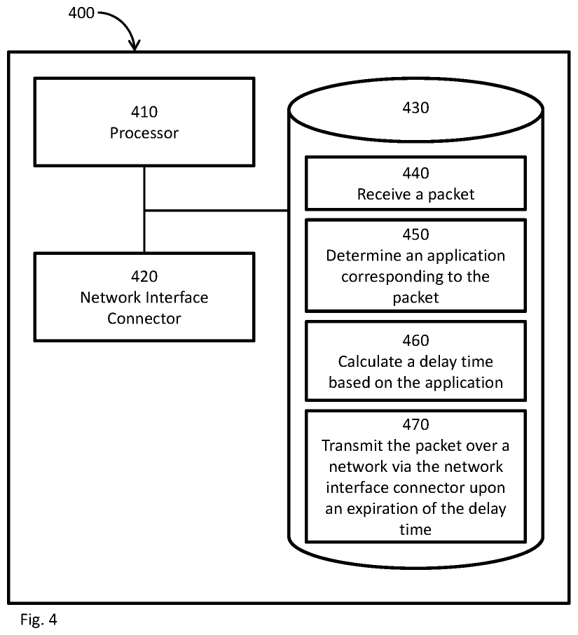

FIG. 1 shows storage 100 to store computer-readable instructions 110, 120, 130, 140 to calculate a delay time for a packet in accordance with various examples. The computer-readable instructions 110, 120, 130, 140 may be executed by a processor, such as the processor described in connection with FIG. 4 below. Storage 100 may comprise volatile or non-volatile memory to store data or computer-readable instructions, such as static random access memory (SRAM), dynamic random access memory (DRAM), a hard drive, solid state drive (SSD), Flash memory, or electrically erasable programmable read only memory (EEPROM). Storage 100 may be part of an overall system, such as a computer system. Storage 100 may include instructions 110 to receive a packet. The packet may be a network packet to transmit across a network. The network may be a local area network, a wide area network, a public network, a private network, or any number of other networks. The network may connect to the Internet. The packet may be transmitted across a bus, such as an internal computer bus or via an external bus like a universal serial bus (USB). Storage 100 may include instructions 120 to determine a priority level of the packet. In various examples, there may be a limited number of defined priority levels, such as high, medium, and low. The number of priority levels may be open-ended based on the present circumstances of an overall system. Storage 100 may include instructions 130 to calculate a delay time based on the priority level. The delay time may be based on an amount of time the packet may be delayed before the connection between the local system and a remote system times out. Calculation of the delay time may consider the travel time of the packet across the network and the amount of precision in delaying the packet. Storage 100 may include instructions 140 to transmit the packet over a network upon an expiration of the delay time.

The computer-readable instructions 110, 120, 130, 140 may be part of a driver in a network driver stack. A driver provides a software interface for accessing devices in a computer system. The corresponding device may be a physical device or a virtual device. The driver may receive packets to be transmitted over a network. The driver may determine the priority levels of the packets to be transmitted. Higher priority packets may be passed along to the next driver in the stack without any delay. Lower priority packets may be passed along to the next driver in the stack after expiration of a delay time. The amount of the delay time may be different based on the application from which the packet originates. The driver may be able to determine whether there is a surplus or scarcity of network bandwidth and pass along lower priority packets if there is a surplus of network bandwidth above the requirements to transmit any higher priority packets.

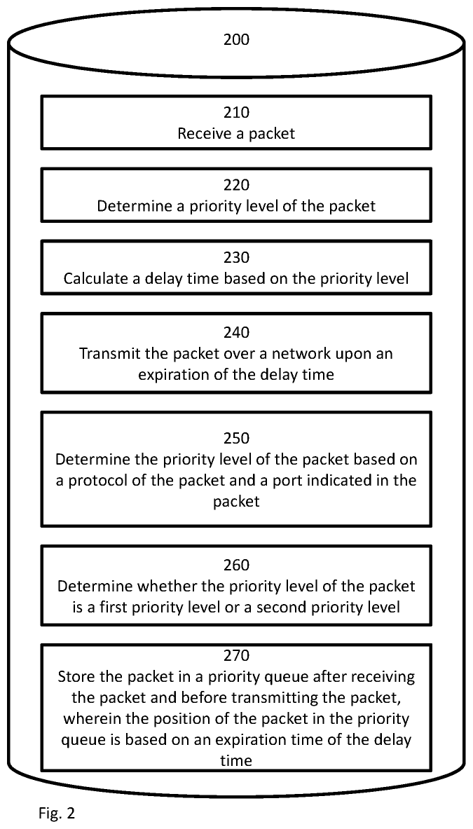

FIG. 2 shows storage 200 to store computer-readable instructions 210, 220, 230, 240, 250, 260, 270 to calculate a delay time for a packet and use of a priority queue in accordance with various examples. The computer-readable instructions 210, 220, 230, 240, 250, 260, 270 may be executed by a processor, such as the processor described in connection with FIG. 4 below. Storage 200 may include instructions 210 to receive a packet. Storage 200 may include instructions 220 to determine a priority level of the packet. Storage 200 may include instructions 230 to calculate a delay time based on the priority level. Storage 200 may include instructions 240 to transmit the packet over a network upon an expiration of the delay time. Storage 200 may include instructions 250 to determine the priority level of the packet based on a protocol of the packet and a port indicated in the packet. The protocol of the packet may be Transmission Control Protocol (TCP), User Datagram Protocol (UDP), Telnet, File Transfer Protocol (FTP), or various other protocols. Determining the priority level of the packet may look at multiple protocols of the packet. Packets may also specify a port, which may be an unsigned number indicating an endpoint for the packet at a destination. A port may indicate what application at a destination is to process the packet or packet data. A port may indicate the type of data being transmitted. In various examples, packets related to e-mail messages may be transmitted via port 25 for Simple Mail Transfer Protocol (SMTP). Packets related to accessing a web page may be transmitted via port 80 for Hypertext Transfer Protocol (HTTP) or port 443 for HTTP Secure (HTTPS). Specific applications may consistently use the same port or port ranges for communication. Storage 200 may include instructions 260 to determine whether the priority level of the packet is a first priority level or a second priority level. The first priority level may be a high priority level. The second priority level may be a low priority level. The high priority level may be used for applications or communications that affect a user's experience, such as voice or video chat, web site access, or a computer game. The low priority level may be used for other applications. Storage 200 may include instructions 270 to store the packet in a priority queue after receiving the packet and before transmitting the packet, wherein the position of the packet in the priority queue is based on an expiration time of the delay time.

In various examples, a priority queue may allow storing packets in an order for transmission, based on when the packets were received and the calculated delay time. A priority queue is based on a first-in-first-out data structure, but giving priority to taking data out of the queue based on some attribute. A first packet may be received at time 0 milliseconds (mS) and be calculated to have a delay time of 30 mS and placed in the priority queue with a priority value of 30 mS (0 mS+30 mS). A second packet may be received at time 5 mS and be calculated to have a delay time of 30 mS and placed in the priority queue with a priority value of 35 mS (5 mS+30 mS). The first packet may be removed from the priority queue before the second packet. A third packet may be received at time 10 mS and be calculated to have a delay time of 15 mS and be placed in the priority queue with a priority value of 25 mS (10 mS+15 mS). The third packet may be removed from the priority before the first packet, as its expiration time of its delay time (25 mS) expires earlier than the expiration time of the delay time of the first packet (30 mS). The time and delay times may be any appropriate unit of time, such as milliseconds, microseconds, or a clock cycle of a clock signal. The priority value may be in different units than the delay time or received time. Expiration of the delay time may be based on recording an expiration time, based on the delay time and current time, and determining when the current time has advanced past the expiration time. Expiration of the delay time may be based on a timer counting when the delay time expires.

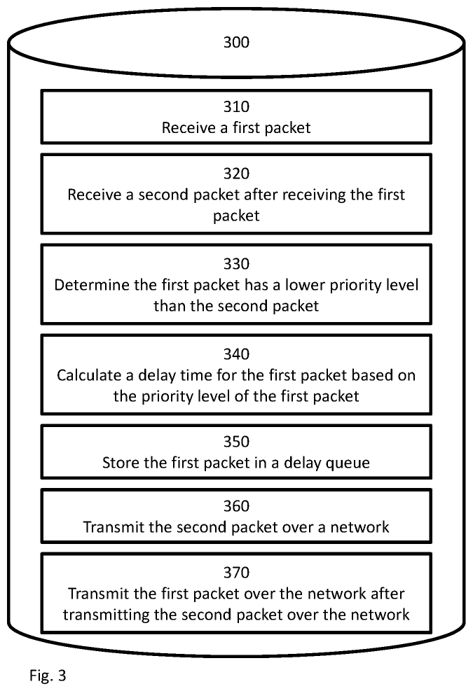

FIG. 3 shows storage 300 to store computer-readable instructions 310, 320, 330, 340, 350, 360, 370 to calculate a delay time for a packet in accordance with various examples. The computer-readable instructions 310, 320, 330, 340, 350, 360, 370 may be executed by a processor, such as the processor described in connection with FIG. 4 below. Storage 300 may include instructions 310 to receive a first packet. Storage 300 may include instructions 320 to receive a second packet after receiving the first packet. Storage 300 may include instructions 330 to determine the first packet has a lower priority than the second packet. Storage 300 may include instructions 340 to calculate a delay time for the first packet based on the priority level of the first packet. Storage 300 may include instructions 350 to store the first packet in a delay queue. Storage 300 may include instructions 360 to transmit the second packet over a network. Storage 300 may include instructions 370 to transmit the first packet over the network after transmitting the second packet over the network.

FIG. 4 shows a computer system 400 to execute computer-readable instructions 440, 450, 450, 470 to calculate a delay time for a packet, according to an example. Computer system 400 may include a processor 410, a network interface connector 420, and storage 430. The processor 410, network interface connector 420, and storage 430 may be coupled together via a bus. Storage 430 may include instructions to receive a packet 440. Storage 430 may include instructions 450 to determine an application corresponding to the packet. Storage 430 may include instructions 460 to calculate a delay time based on the application. Storage 430 may include instructions 470 to transmit the packet over a network via the network interface connector upon an expiration of the delay time. Processor 410 may execute the computer readable instructions 440, 450, 450, 470.

According to various examples, the processor 410 may comprise a microprocessor, a microcomputer, a controller, a microcontroller, a Field Programmable Gate Array (FPGA) or discrete logic. The processor 410 may have a single core or multiple processing cores. Other kinds of processors 410 are also contemplated.

According to various examples, the network interface connector 420 may be an Ethernet card, a wireless Ethernet connector, a Bluetooth connector, or another type of network connector. The network interface connector 420 may have a wired connection to the network or may connect wirelessly. The network interface connector 420 may connect to the Internet, an intranet, a public network, an ad hoc network, or some other network. The network interface connector 420 may allow access to more than one network or more than one type of network. Other kinds of network interface connectors 420 are also contemplated.

According to various examples, the delay time may be calculated based on the application. This may be done by identifying a protocol and port corresponding to the packet and associating that combination of protocol and port with a particular application. The application may be identified by providing an interface by which the application provides the packet and an identification of the application.

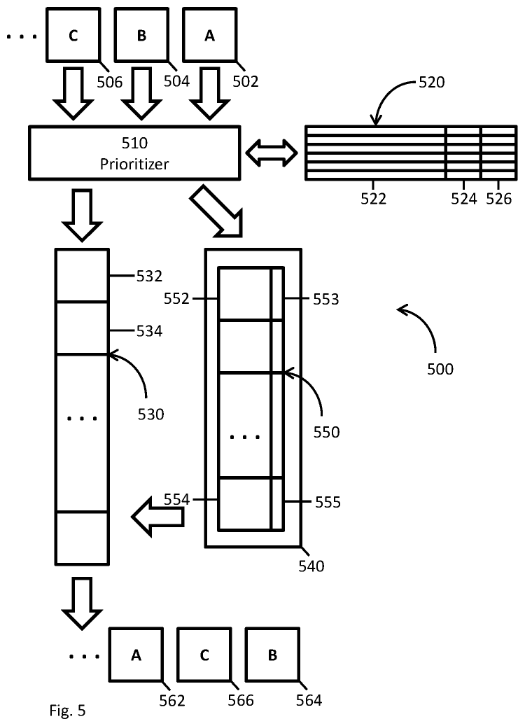

FIG. 5 shows packets 502, 504, 506 being prioritized before transmission over a network, according to an example. Packet 502 may include data A. Packet 504 may include data B. Packet 506 may include data C. Packet 502 may be received before packet 504 and packet 506. Packet 504 may be received before packet 506. Packets 502, 504, 506 may be processed by prioritizer 510. Prioritizer 510 may determine a priority level of packets 502, 504, 506 and a corresponding delay time. To determine a priority level, prioritizer 510 may reference a priority table 520. Priority table 520 may include entries identifying an application 522, specifying a priority level 524, or specifying a delay time 526. Prioritizer 510 may store packets in a transmission queue 530. Transmission queue 530 may include packets 532, 534 queued for transmission over a network. Prioritizer 510 may store packets in a delay queue 540. Delay queue 540 may include packets 552, 554 queued for transmission over a network after a delay time. Delay queue 540 may comprise a priority queue 550. Priority queue may comprise entries including packets 552, 554 and their corresponding expiration times 553, 555, based on their delay times and when the packets 552, 554 were received. On expiration of expiration time 555, packet 554 may be removed from delay queue 540 and stored in transmission queue 530. Removing packet 554 from delay queue 540 may remove packet 554 from priority queue 550. Packets 534, 532 may be removed from transmission queue 530 and transmitted via a network. Data A, B, and C that were received in packets 502, 504, 506 may be transmitted via a network in a different order than they were received. Packets 562, 502 may correspond to each other and include data A. Packets 564, 504 may correspond to each other and include data B. Packets 566, 506 may correspond to each other and include data C. Packet 564 may be transmitted over the network before packet 566 and packet 562. Packet 566 may be transmitted over the network before packet 562. Though packets 502, 504, 506 were received in the order of A, B, then C, corresponding packets 562, 564, 566 may be transmitted in the order of B, C, then A.

Priority table 520 may be implemented as an array, database, or other appropriate data structure. The column identifying an application 522 may include information about protocols and ports used by the application. Prioritizer 510 may use data in the identifying an application column 522 to determine which row of priority table 520 corresponds to a particular packet. Prioritizer 510 may use data in the corresponding row of the specifying a priority level column 524 to determine a priority level of the packet. Prioritizer 510 may use data in the corresponding row of the specifying a delay time column 526 in calculating a delay time or expiration time for the packet. In various examples, the priority table 520 may store the identifying an application 522 data, specifying a priority level 524 data, and specifying a delay time 526 data separately. Prioritizer 510 may access priority table 520 to identify an application. Prioritizer 510 may access priority table 520 to determine a priority level, based on identification of the application. Prioritizer 510 may access priority table 520 to determine a delay time based on the priority level. In various examples, priority table 520 may include entries specifying protocol and port combinations and corresponding delay times, without further identifying particular applications or explicitly specifying a priority level. A priority level may be inherent in the delay time specified for a packet.

In various examples, an application may use multiple channels in communicating data across the network. A video chat program may use one protocol and port for transmission of video, another protocol or port for transmission of audio, and another protocol or port for transmission of status data. Video transmissions may be a higher priority than audio transmissions, which may be a higher priority than transmissions of status data. Priority table 520 may include different entries for these different transmission categories from the same application.

In various examples, the priority levels may be based on the type of transmission. Packets corresponding to video transmissions may be the same priority level as other packets corresponding to video transmissions. Packets corresponding to audio transmissions may be the same priority level as other packets corresponding to audio transmissions, but a different priority level than packets corresponding to video transmissions.

The following examples may further assist in understanding the concepts discussed above.

A network driver may receive three packets 502, 504, 506 from three different applications. Packet 502 may be received first at time 23 mS, packer 504 second at time 31 mS, and packet 506 third at time 55 mS. Prioritizer 510 may examine packet 502 to identify a protocol and port corresponding to the packet 502. Prioritizer 510 may use the protocol and port to access priority table 520 and determine packet 502 has a low priority and calculate a delay time of 50 mS with an expiration time of 73 mS. Prioritizer 510 may store packet 502 in delay queue 540, where it is further stored in priority queue 550 based upon its expiration time of 73 mS. Prioritizer 510 may similarly examine packet 504 and access priority table 520 to determine packet 504 is a high priority packet that should not be delayed. Prioritizer 510 may store packet 504 in transmission queue 530. Packet 504 may be transmitted across the network as packet 564 at the next available transmission. Prioritizer 510 may similarly examine packet 506 and access priority table 520 to determine packet 504 is a medium priority packet. Prioritizer 510 may calculate a delay time of 15 mS with an expiration time of 70 mS. Prioritizer 510 may store packet 506 in delay queue 540, where it is further stored in priority queue 550 based on its expiration time of 70 mS. Upon expiration of the expiration time of packet 506, packet 506 may be moved to the transmission queue 530. Packet 506 may be moved to transmission queue 530 even if additional packets are being received with a high priority that should not be delayed. Upon expiration of the expiration time of packet 502, packet 502 may be moved to the transmission queue 530. Packet 502 may be moved to transmission queue 530 even if additional packets are being received with a high priority that should not be delayed. In various examples, packet 506 may be at the head of the priority queue 550 prior to expiration of its expiration time. If the transmission queue 530 is not full but ready to transmit, packet 506 may be moved from the priority queue 550 to the transmission queue 530 before expiration of its expiration time, in order to make use of available bandwidth. Similarly, packet 502 may be transmitted before expiration of its expiration time in order to make use of available bandwidth.

In various examples, a high priority packet 504 may be calculated to have a delay time of 0 mS and placed in the priority queue 550. Packet 504 may be received at time 31 mS. If the head of the priority queue 550 has an expiration time of 32 mS, packet 504 may be stored as the new head of priority queue 550. If the head of priority queue 550 has an expiration time of 30 mS, packet 504 may be stored after that entry in the priority queue 550. This may prevent data starvation of applications during heavy bandwidth use by high priority applications. If the head of priority queue 550 has an expiration time of 30 mS, priority may be given to the current head of priority queue 550 or to packet 504.

High priority packets may generally be transmitted as they are received, allowing for buffering. When bandwidth is scarce, lower priority packets may be delayed for an amount of time before being transmitted. If bandwidth is scarce for an extended period of time, lower priority packets may still be transmitted after their delay time, even if high priority packets could consume the entire bandwidth. This may prevent data starvation of applications with lower priority transmissions. If there is a surplus of bandwidth, high priority packets and lower priority packets may generally be transmitted as they are received. Lower priority packets may be slightly delayed due to buffering and exact timing of transmissions, but may not wait until expiration of the delay time if there is surplus bandwidth available.

In various examples, the delay queue may also prioritize packets based on the priority level. If there is a surplus of bandwidth beyond that used to transmit high priority packets, medium priority packets may be moved from the delay queue to the transmission queue before moving low priority packets to the transmission queue, even if the low priority packets have an expiration time prior to the medium priority packets being moved.

Delay times for packets may be based on empirical evidence and the behavior of specific applications. An application may have a data channel established with an application executing on another computer system across the network. The data channel may time out after a certain period of non-responsiveness by one of the systems. To prevent time-out of the data channel, messages may be exchanged before time out. Additional bandwidth may be used to reestablish a channel that has timed out, as opposed to maintaining the channel as active. For example, if a channel times out after 100 milliseconds of inactivity, a delay time of 1 second may be inappropriate, but a delay time of 50 milliseconds may maintain the active channel. The delay time may be based on the amount of time before a channel or connection times out across the network, the speed of the computer system, and the activity level of the computer system. The delay time may take into account different kinds of signals, such as acknowledge signals, which may be given higher priority in order to avoid the retransmission of data.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A non-transitory computer-readable medium storing machine-readable instructions which, when executed by a processor of an electronic device, cause the processor to:
receive a packet;
determine a priority level of the packet;
calculate a delay time based on the priority level; and
transmit the packet over a network upon an expiration of the delay time.

2. The computer-readable medium of claim 1, wherein the machine-readable instructions, when executed by the processor, cause the processor to determine the priority level of the packet based on a protocol of the packet and a port indicated in the packet.

3. The computer-readable medium of claim 1, wherein the machine-readable instructions, when executed by the processor, cause the processor to determine whether the priority level of the packet is a first priority level or a second priority level.

4. The computer-readable medium of claim 1, wherein the machine-readable instructions, when executed by the processor, cause the processor to store the packet in a priority queue after receiving the packet and before transmitting the packet.

5. The computer-readable medium of claim 4, wherein the position of the packet in the priority queue is based on an expiration time of the delay time.

6. A non-transitory computer-readable medium storing machine-readable instructions which, when executed by a processor of an electronic device, cause the processor to:
receive a first packet;
receive a second packet after receiving the first packet;
determine the first packet has a lower priority level than the second packet;
calculate a delay time for the first packet based on priority level of the first packet;
store the first packet in a delay queue;
transmit the second packet over a network; and
transmit the first packet over the network after transmitting the second packet over the network.

7. The computer-readable medium of claim 6, wherein the machine-readable instructions, when executed by the processor, cause the processor to store the second packet in a transmission queue.

8. The computer-readable medium of claim 7, wherein the machine-readable instructions, when executed by the processor, cause the processor to:
determine the transmission queue is below transmission capacity; and
in response to the determination, remove the first packet from the delay queue and store the first packet in the transmission queue prior to an expiration of the delay time.

9. The computer-readable medium of claim 6, wherein the machine-readable instructions, when executed by the processor, cause the processor to:
receive a third packet after receiving the first packet;
determine the third packet has a priority level in between the priority level of the first packet and the priority level of the second packet;
calculate a second delay time for the third packet based on the priority level of the third packet, wherein an expiration of the second delay time is prior to an expiration of the delay time;
store the third packet in the delay queue; and
transmit the third packet over the network upon expiration of the second delay time, after transmitting the second packet over the network and before transmitting the first packet over the network.

10. The computer-readable medium of claim 6, wherein the delay queue includes a priority queue and a priority of the first packet in the priority queue is based on an expiration time of the delay time.

11. A system comprising:
a processor; and
a network interface connector coupled to the processor, wherein the processor is to:
receive a packet;
determine an application corresponding to the packet;
calculate a delay time based on the application; and
transmit the packet over a network via the network interface connector upon an expiration of the delay time.

12. The system of claim 11, wherein the processor is further to calculate the delay time based on a value in a priority table, wherein the value corresponds to the application.

13. The system of claim 11, wherein the processor is further to:
determine a channel corresponding to the packet;
calculate the delay time based on the channel;
receive a second packet;
determine the application corresponds to the second packet;
determine a second channel corresponding to the second packet;
calculate a second delay time based on the second channel, wherein the delay time is different than the second delay time.

14. The system of claim 11, wherein the processor is further to determine the application by determining a protocol of the packet and a port indicated in the packet.

15. The system of claim 11, wherein the processor is further to:
receive a second packet after receiving the packet and before transmitting the packet;
determine the second packet has a higher priority level than the packet;
transmit the second packet over the network via the network interface after transmitting the packet, based on the expiration of the delay time.
